(19) United States
(12) Patent Application Publication
(10) Pub. No.: US 2026/0369669 A1
(43) Pub. Date: Nov. 19, 2026

(54) METHOD FOR MANUFACTURING MODIFIED OXIDE CERAMIC POWDER

(71) Applicant: ZHI FENG LUO, Shenzhen (CN)

(72) Inventor: ZHI FENG LUO, Shenzhen (CN)

(21) Appl. No.: 19/207,396

(22) Filed: May 14, 2025

(51) Int. Cl. H01M 10/0562; C01G 25/00; H01M 10/052

(52) U.S. Cl. CPC H01M 10/0562; C01G 25/006; H01M 10/052; C01P 2002/52; C01P 2002/76; C01P 2004/50; C01P 2004/62; C01P 2006/40; H01M 2300/0071

(57) ABSTRACT

A method for manufacturing a modified oxide ceramic powder includes the following steps. Step A: mixing a zirconium-contained compound, a lanthanum-contained compound, a copper-contained compound, an aluminum-contained compound with a first deionized water to form plural first mixture particles. Step B: performing a concentration on the first mixture particles to form a first mixed powder. Step C: performing first stage oxygen-free sintering operation on the first mixed powder to form a complex ceramic compound using a sintering furnace. Step D: mixing a second deionized water, a lithium-contained compound and the complex ceramic compound to form plural second mixture particles. Step E: performing a concentration on the second mixture particles to form a second mixed powder. Step F: placing the second mixed powder into the sintering furnace. Step G: performing a second stage sintering operation to form plural modified LLZO particles.

### FIELD OF THE INVENTION

The present invention is related to solid electrolyte, and in particular to a method for manufacturing a modified oxide ceramic powder.

### BACKGROUND OF THE INVENTION

In prior arts, the method for manufacturing a solid electrolyte of a lithium battery is placing a composite slurry formed by three initial compounds ZrO₂, La₂O₃ and Li₂CO₃ with a specific ratio into a ball mill, then performing a mixing and grinding, and then using oxygen to perform an single-stage sintering.

However, in above single-stage sintering, due to different temperature and phase transition conditions in the powder groups, some oxides will have oxygen deficiency or insufficient energy, resulting in the inability to form the correct phase (cubic crystal system), which causes the phase transition process messy and inconsistent. As a result, the final product has a poor efficiency for conducting lithium ions. Moreover, the lithium source will be constantly losing during the single-stage sintering, which causes an incomplete formation of the final product. Although many methods are developed to avoid above problems, these methods still make it difficult to unify the complex crystalline phases, and they even accelerate the depletion of the lithium source, which causes the degradation of the LLZO (lithium lanthanum zirconium oxide) with an originally stabilized cubic crystalline. Even if the lithium source can be replenished, the process is still lengthy and results in excessive material and energy losses, which is not conducive to the production and product control and makes it difficult to market the product.

### SUMMARY OF THE INVENTION

Accordingly, for improving above mentioned defects in the prior art, the object of the present invention is to provide a method for manufacturing a modified oxide ceramic powder, wherein the first stage oxygen-free sintering operation is performed under the stew protection of the oxygen-free environment. Because no lithium-contained compound has been added, a high purity of complex ceramic compound containing copper, aluminum, zirconium and lanthanum can be produced without significant lithium depletion in the sintering. When the intermediate (complex ceramic compound) having stable and even phases is obtained after the first stage oxygen-free sintering operation, the lithium-contained compound and oxygen are added to perform the reaction of the second stage sintering operation. Therefore, the modified LLZO crystal structure mainly formed by cubic crystal lattices can be produced, which has a higher lithium ions conducting performance and improves the whole performance of the battery.

To achieve above object, the present invention provides a method for manufacturing a modified oxide ceramic powder comprising the steps of: step A: taking a ball mill and placing a first deionized water into the ball mill; then placing a solid content formed by a zirconium-contained compound, a lanthanum-contained compound, a copper-contained compound and an aluminum-contained compound into the ball mill and mixing and grinding the solid content with the first deionized water by a specific mixing ratio to form a plurality of first mixture particles using the ball mill; wherein the ball mill has a plurality of zirconium balls for mixing and grinding to cause that each of first mixture particles has a particle size smaller than a specific size after the mixing and grinding of the ball mill; step B: taking out the first mixture particles from the ball mill and placing the first mixture particles into a rotary evaporator; and then performing a concentration to remove the first deionized water from the first mixture particles to form a first mixed powder using the rotary evaporator; step C: performing a first stage oxygen-free sintering operation; the first stage oxygen-free sintering operation being performed by placing the first mixed powder into a sintering furnace, and then performing an oxygen-free sintering on the first mixed powder in an oxygen-free stew environment to form a complex ceramic compound using the sintering furnace; wherein the complex ceramic compound contains copper, aluminum, zirconium and lanthanum; and in the oxygen-free sintering, the zirconium-contained compound, the lanthanum-contained compound, the copper-contained compound, the aluminum-contained compound in the first mixture particles are reacted to form the complex ceramic compound; step D: placing a second deionized water into the ball mill and then placing a lithium-contained compound and the complex ceramic compound into the ball mill; and then mixing and grinding the second deionized water, the lithium-contained compound and the complex ceramic compound by a specific mixing ratio to form a plurality of second mixture particles using the ball mill; step E: placing the second mixture particles into the rotary evaporator and then performing a concentration to remove the second deionized water from the second mixture particles to form a second mixed powder using the rotary evaporator; step F: placing the second mixed powder into the sintering furnace and increasing the temperature of the sintering furnace to a first temperature and holding the first temperature for a first duration; step G: performing a second stage sintering operation to perform an oxygen assisted sintering reaction; the second stage sintering operation being performed by decreasing the first temperature of the sintering furnace to a second temperature and then injecting an oxygen (O₂) into the sintering furnace, and then increasing the second temperature to a third temperature and heating the second mixed powder at the third temperature for a second duration to perform the oxygen assisted sintering reaction; wherein in the heating of the second mixed powder, the lithium-contained compound and the complex ceramic compound perform the oxygen assisted sintering reaction to form a plurality of modified LLZO (modified lithium lanthanum zirconium oxide) particles which are formed by modified LLZO (modified lithium lanthanum zirconium oxide); and the modified LLZO particles are coalesced into a plurality of modified LLZO agglomerates which have a plurality of cubic crystal lattices.

### BRIEF DESCRIPTION OF THE DRAWINGS

FIG. 1 is a steps flow diagram showing the process of the present invention.

FIG. 2 is a schematic view showing the manufacturing of the complex ceramic compound.

FIG. 3 is a schematic view showing the manufacturing of the modified LLZO agglomerates.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

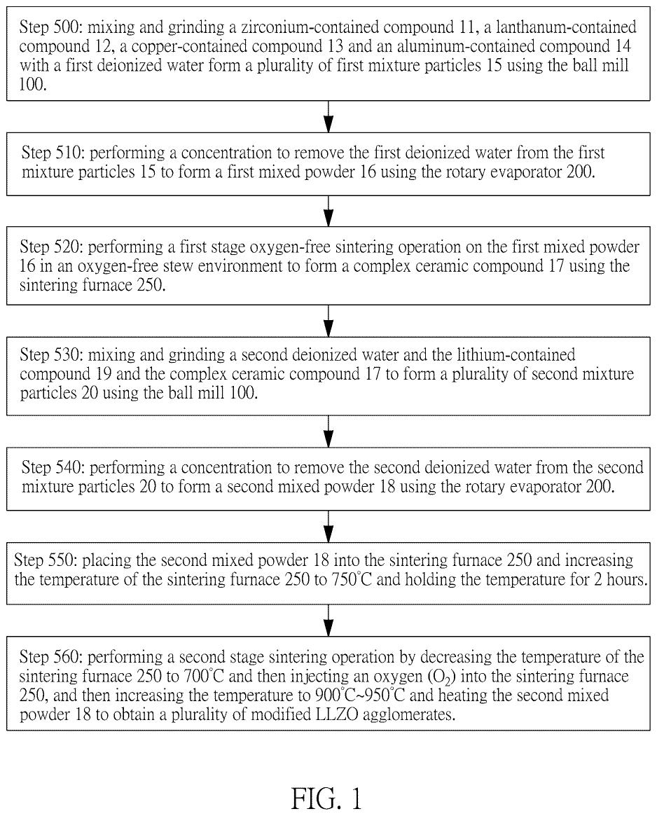

As illustrating in FIGS. 1 to 5, the present invention provides a method for manufacturing a modified oxide ceramic powder. The method comprises the following steps of:

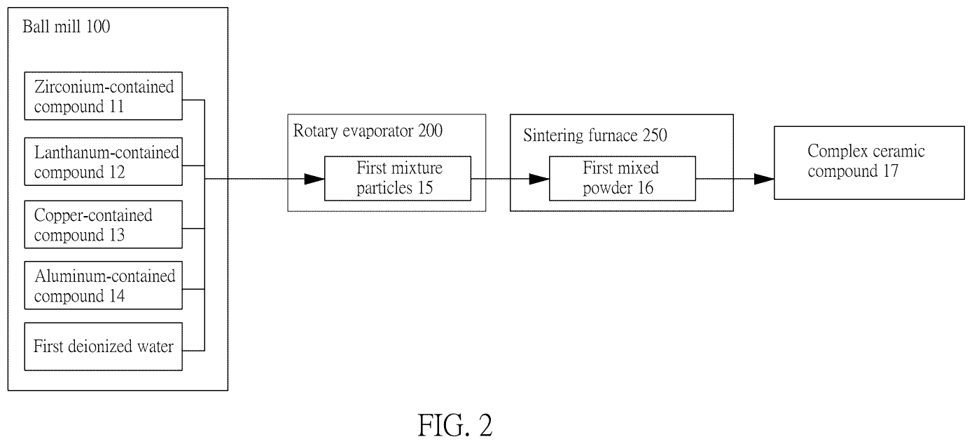

Step 500: taking a ball mill 100 and placing a first deionized water into the ball mill 100, as shown in FIG. 2. Then placing a solid content formed by a zirconium-contained compound 11, a lanthanum-contained compound 12, a copper-contained compound 13 and an aluminum-contained compound 14 into the ball mill 100 and mixing and grinding the zirconium-contained compound 11, the lanthanum-contained compound 12, the copper-contained compound 13, the aluminum-contained compound 14 with the first deionized water by a specific mixing ratio to form a plurality of first mixture particles 15 using the ball mill 100.

The ball mill 100 has a plurality of zirconium balls for mixing and grinding to cause that each of first mixture particles 15 has a particle size smaller than 500 nm after the mixing and grinding of the ball mill 100. A rotation speed of the first ball mill 100 is 2600 rpm±20%. Each of the zirconium balls has a grain size of 0.8 mm to 1.2 mm. A filling ratio of a total volume of the zirconium balls and the first mixture particles 15 is 65% to 80%, which is a ratio of a total volume of the zirconium balls and the first mixture particles 15 to a grinding volume of the ball mill 100. A mixing and grinding time of the ball mill 100 is 0.25 to 3 hours (preferably 0.25 to 1.5 hours). A mixing and grinding temperature of the ball mill 100 is 15 °C to 30 °C (preferably 15 °C to 25 °C). A weight percentage of the solid content in the first mixture particles 15 is 25 wt %~40 wt %.

The zirconium-contained compound 11 is selected from one of zirconium nitrate (Zr(NO₃)₄), zirconium dioxide (ZrO₂) and zirconium(IV) hydroxide (Zr(OH)₄). The lanthanum-contained compound 12 is selected from one of lanthanum(III) nitrate (La(NO₃)₃), lanthanum(III) oxide (La₂O₃) and lanthanum hydroxide (La(OH)₃). The copper-contained compound 13 is selected from one of copper(II) nitrate (Cu(NO₃)₂), copper(II) oxide (CuO) and copper(II) hydroxide (Cu(OH)₂). The aluminum-contained compound 14 is selected from one of aluminium(III) oxide (Al₂O₃), aluminium hydroxide (Al(OH)₃) and aluminium nitrate (Al(NO₃)₃).

Step 510: taking out the first mixture particles 15 from the ball mill 100 and placing the first mixture particles 15 into a rotary evaporator 200. Then performing a concentration on the first mixture particles 15 to remove the first deionized water from the first mixture particles 15 to form a first mixed powder 16 using the rotary evaporator 200. Preferably, the rotary evaporator 200 is an oil bath assisted rotary evaporator. An oil path temperature of the rotary evaporator 200 is 120 °C. A rotation speed of the rotary evaporator 200 is 25 rpm. A concentration time of the rotary evaporator 200 is 2.5 to 3 hours.

Step 520: performing a first stage oxygen-free sintering operation. Referring the FIG. 2, the first stage oxygen-free sintering operation is performed by placing the first mixed powder 16 into a sintering furnace 250, and then performing an oxygen-free sintering on the first mixed powder 16 in an oxygen-free stew environment to form a complex ceramic compound 17 (La₂Zr₂O₇) using the sintering furnace 250. The complex ceramic compound 17 contains copper, aluminum, zirconium, and lanthanum. The oxygen-free sintering may be a vacuum sintering or an atmosphere protected sintering.

Preferably, the oxygen-free sintering is an atmosphere protected sintering using an atmosphere formed by nitrogen (N₂) and argon (Ar). A ratio between a volume of the nitrogen and a volume of the argon is 98:2. The oxygen-free sintering is performed by increasing a temperature of the sintering furnace 250 to 750 °C at a rate of 1 °C to 5 °C (preferably 2 °C) per minute to heat the first mixture particles 15 for 5 to 6 hours (preferably 6 hours) in the stew protection of the atmosphere formed by the nitrogen and argon, which causes the zirconium-contained compound 11, the lanthanum-contained compound 12, the copper-contained compound 13, the aluminum-contained compound 14 in the first mixture particles 15 are reacted to form the complex ceramic compound 17. During the oxygen-free sintering, the atmosphere formed by the nitrogen and argon is replaced and replenished at a rate of 0.05 L to 0.15 L per minute.

In the present invention, the zirconium-contained compound 11 is ZrO₂. The lanthanum-contained compound 12 is La₂O₃. The copper-contained compound 13 is CuO. The aluminum-contained compound 14 is Al₂O₃. However above types of the compounds are not intended to limit the scope of the present invention. All combinations of the types of the compounds permitted in the preceding paragraph with respect to the zirconium-contained compound 11, the lanthanum-contained compound 12, the copper-contained compound 13, and the aluminum-contained compound 14 can be also applied to the following steps of the method of the present invention.

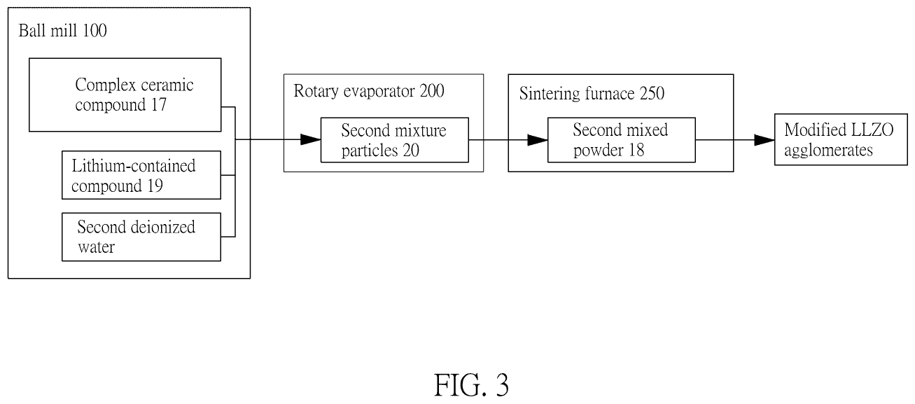

Step 530: placing a second deionized water into the ball mill 100 and then placing a lithium-contained compound 19 and the complex ceramic compound 17 into the ball mill 100 (as shown in FIG. 3). Then mixing and grinding the second deionized water, the lithium-contained compound 19 and the complex ceramic compound 17 by a specific mixing ratio to form a plurality of second mixture particles 20 using the ball mill 100. Each of the second mixture particles 20 has a particle size less than 500 nm. The rotation speed, a filling ratio of a total volume of the zirconium balls and the second mixture particles 20, the mixing and grinding time, and the mixing and grinding temperature of the ball mill 100 in the step 530 are identical to the rotation speed, the filling ratio of a total volume of the zirconium balls and first mixture particles 15, the mixing and grinding time, and the mixing and grinding temperature of the ball mill 100 in the step 500, respectively.

The lithium-contained compound 19 is selected from one of lithium nitrate (LiNO₃), lithium oxide (Li₂O), lithium carbonate (Li₂CO₃) and lithium hydroxide (LiOH).

Step 540: placing the second mixture particles 20 into the rotary evaporator 200 and then performing a concentration on the second mixture particles 20 to remove the second deionized water from the second mixture particles 20 to form a second mixed powder 18 using the rotary evaporator 200. Preferably, the oil path temperature of the rotary evaporator 200 is 120 °C. A rotation speed of the rotary evaporator 200 is 25 rpm. A concentration time of the rotary evaporator 200 is 2.5 to 3 hours.

The lithium-contained compound 19 is added in the step 530 after the forming of the complex ceramic compound 17. Compared to traditional methods of adding all materials at once, the present invention can reduce the loss of lithium by the first stage oxygen-free sintering operation and have a better formation result of the complex ceramic compound 17.

Step 550: placing the second mixed powder 18 into the sintering furnace 250 and increasing the temperature of the sintering furnace 250 to a first temperature and holding the first temperature for a first duration. The first temperature is 750 °C and the first duration is 2 hours.

Step 560: performing a second stage sintering operation to perform an oxygen assisted sintering reaction. The second stage sintering operation is performed by decreasing the first temperature of the sintering furnace 250 to a second temperature and then injecting an oxygen (O₂) into the sintering furnace 250, and then increasing the second temperature to a third temperature and heating the second mixed powder 18 at the third temperature for a second duration to perform the oxygen assisted sintering reaction. The second temperature is 700 °C. The third temperature is 900 °C~950 °C. The second duration is 6~9 hours (preferably 7 hours). The second temperature is increased to the third temperature at a rate of 1 °C to 3 °C (preferably 2 °C) per minute. In the heating of the second mixed powder 18, the lithium-contained compound 19 and the complex ceramic compound 17 perform the oxygen assisted sintering reaction to form a plurality of modified LLZO (modified lithium lanthanum zirconium oxide) particles which are formed by modified LLZO (modified lithium lanthanum zirconium oxide). The modified LLZO particles are coalesced into a plurality of modified LLZO agglomerates which have a plurality of cubic crystal lattices.

In the embodiment, the lithium-contained compound 19 is lithium carbonate (Li₂CO₃). The oxygen assisted sintering reaction is performed by Li₂CO₃, CuO, Al₂O₃, La₂O₃ and the complex ceramic compound 17.

In the step 560, 1 to 3 liters of the oxygen is added per minute for every 1 kg of the second mixed powder 18, which is used to perform the oxygen assisted sintering reaction of the lithium-contained compound 19 and the complex ceramic compound 17 perform, and producing the modified LLZO particles formed by cubic crystal lattices. The modified LLZO is Li_{(7-x-y)}Cu_{x/2}Al_{y/3}La₃Zr₂O₁₂, which can be used as a solid electrolyte of a lithium battery for conducting lithium ions. The copper (Cu) and aluminum (Al) are contained in the Li_{(7-x-y)}Cu_{x/2}Al_{y/3}La₃Zr₂O₁₂, which causes that a equivalence ratio (ER) of the lithium (Li) of the Li_{(7-x-y)}Cu_{x/2}Al_{y/3}La₃Zr₂O₁₂ is reduced from 7 to 6.2~6.9 compared to a normal LLZO (Li₇La₃Zr₂O₁₂) produced without the addition of copper (Cu) and aluminum (Al). The cubic crystal lattices of the Li_{(7-x-y)}Cu_{x/2}Al_{y/3}La₃Zr₂O₁₂ have larger channels for increasing the conduction rate of lithium ions.

A chemical equation to produce the modified LLZO through the first stage oxygen-free sintering operation and the second stage sintering operation is:

$$4 {ZrO}_{2} + {3 L {a}_{2} O}_{3} + ( 7 - x - y ) {Li}_{2} {CO}_{3} + x CuO + \frac{y}{3} {Al}_{2} {O}_{3} \to 2 {Li}_{( 7 - x - y )} {Cu}_{\frac{x}{2}} {Al}_{\frac{y}{3}} {La}_{3} Z {r}_{2} {O}_{12} + ( 7 - x - y ) {CO}_{2}$$

wherein x>0, y>0 and 7−x−y>0.

In the prior art, the normal LLZO (Li₇La₃Zr₂O₁₂) is used as a solid electrolyte of an anode and a cathode of a battery. The lithium ion channels of the Li₇La₃Zr₂O₁₂ produce very limited lithium ion conduction. While the conduction has some effect, it is still not comparable to a liquid electrolyte and therefore limits the rate of lithium ion conduction, which limits the rate of charging and power production.

Therefore, the method of the present invention provides to improve the disadvantage of above prior art is adding CuO and Al₂O₃ to the prior chemical reaction “La₂Zr₂O₇+Li₂CO₃+O₂” to cause that some of the lithium (Li) of the normal LLZO (Li₇La₃Zr₂O₁₂) are replaced by the copper (Cu) and aluminum (Al) to form the Li_{(7-x-y)}Cu_{x/2}Al_{y/3}La₃Zr₂O₁₂, which is a Cu&Al doped LLZO, that is, the modified LLZO obtained in the present invention.

In the Li_{(7-x-y)}Cu_{x/2}Al_{y/3}La₃Zr₂O₁₂, Cu and Al replace some of the Li of the Li₇La₃Zr₂O₁₂. Because copper (Cu) and aluminum (Al) have higher charges and larger atomic sizes, the crystal structure formed by the cubic crystal lattices of the Li_{(7-x-y)}Cu_{x/2}Al_{y/3}La₃Zr₂O₁₂ creates larger lithium ion channels, which accelerates the rate of lithium ion conduction in the solid electrolyte.

In above chemical equation, a mole ratio between the ZrO₂, Li₂CO₃, CuO, Al₂O₃, La₂O₃ is 4:(7−x−y):x:y/3:3. When the mole ratio is not 4:(7−x−y):x:y/3:3, the chemical equation can still be performed and some initial compounds which do not react will be remained in the final products. Therefore, the scope of the present invention also includes the initial compounds of the chemical equation in various different ratios. In the chemical equation, 0<x<0.8, 0<y<0.8 and 0.1<x+y<0.8. Preferably, 0<x<0.35, 0<y<0.45 and 0.3<x+y<0.8.

In the present invention, when an initial mole ratio of the zirconium-contained compound 11, the lanthanum-contained compound 12, the copper-contained compound 13, the aluminum-contained compound 14 and the lithium-contained compound 19 is identical to a mole ratio of reaction coefficients in the chemical equation, the chemical equation achieves a complete reaction. When the initial mole ratio is not identical to the mole ratio of reaction coefficients in the chemical equation, the complete reaction is not achieved, and a plurality of impurities are formed by surplus molecules which are not reacted in the reaction of the chemical equation. Such conditions which produce impurities due to not meeting the ratio for the complete reaction, are within the scope of the present invention.

The advantages of the present invention are that the first stage oxygen-free sintering operation is performed under the stew protection of the oxygen-free environment. Because no lithium-contained compound has been added, a high purity of complex ceramic compound containing copper, aluminum, zirconium and lanthanum can be produced without significant lithium depletion in the sintering. When the intermediate (complex ceramic compound) having stable and even phases is obtained after the first stage oxygen-free sintering operation, the lithium-contained compound and oxygen are added to perform the reaction of the second stage sintering operation. Therefore, the modified LLZO crystal structure mainly formed by cubic crystal lattices can be produced, which has a higher lithium ions conducting performance and improves the whole performance of the battery.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a modified oxide ceramic powder comprising the steps of:
step A: taking a ball mill and placing a first deionized water into the ball mill; then placing a solid content formed by a zirconium-contained compound, a lanthanum-contained compound, a copper-contained compound and an aluminum-contained compound into the ball mill and mixing and grinding the solid content with the first deionized water by a specific mixing ratio to form a plurality of first mixture particles using the ball mill; wherein the ball mill has a plurality of zirconium balls for mixing and grinding to cause that each of first mixture particles has a particle size smaller than a specific size after the mixing and grinding of the ball mill;
step B: taking out the first mixture particles from the ball mill and placing the first mixture particles into a rotary evaporator; and then performing a concentration to remove the first deionized water from the first mixture particles to form a first mixed powder using the rotary evaporator;
step C: performing a first stage oxygen-free sintering operation; the first stage oxygen-free sintering operation being performed by placing the first mixed powder into a sintering furnace, and then performing an oxygen-free sintering on the first mixed powder in an oxygen-free stew environment to form a complex ceramic compound using the sintering furnace; wherein the complex ceramic compound contains copper, aluminum, zirconium and lanthanum; and in the oxygen-free sintering, the zirconium-contained compound, the lanthanum-contained compound, the copper-contained compound, the aluminum-contained compound in the first mixture particles are reacted to form the complex ceramic compound;
step D: placing a second deionized water into the ball mill and then placing a lithium-contained compound and the complex ceramic compound into the ball mill; and then mixing and grinding the second deionized water, the lithium-contained compound and the complex ceramic compound by a specific mixing ratio to form a plurality of second mixture particles using the ball mill;
step E: placing the second mixture particles into the rotary evaporator and then performing a concentration to remove the second deionized water from the second mixture particles to form a second mixed powder using the rotary evaporator;
step F: placing the second mixed powder into the sintering furnace and increasing the temperature of the sintering furnace to a first temperature and holding the first temperature for a first duration;
step G: performing a second stage sintering operation to perform an oxygen assisted sintering reaction; the second stage sintering operation being performed by decreasing the first temperature of the sintering furnace to a second temperature and then injecting an oxygen (O₂) into the sintering furnace, and then increasing the second temperature to a third temperature and heating the second mixed powder at the third temperature for a second duration to perform the oxygen assisted sintering reaction; wherein in the heating of the second mixed powder, the lithium-contained compound and the complex ceramic compound perform the oxygen assisted sintering reaction to form a plurality of modified LLZO (modified lithium lanthanum zirconium oxide) particles which are formed by modified LLZO (modified lithium lanthanum zirconium oxide); and the modified LLZO particles are coalesced into a plurality of modified LLZO agglomerates which have a plurality of cubic crystal lattices.

2. The method as claimed in claim 1, wherein in the step A, the particle size of each of first mixture particles is smaller than 500 nm after the mixing and grinding of the ball mill.

3. The method as claimed in claim 2, wherein in the step A, a rotation speed of the first ball mill is 2600 rpm±20%; each of the zirconium balls has a grain size of 0.8 mm to 1.2 mm; a filling ratio of a total volume of the zirconium balls and the first mixture particles is 65% to 80%, which is a ratio of a total volume of the zirconium balls and the first mixture particles to a grinding volume of the ball mill; a mixing and grinding time of the ball mill is 0.25 to 3 hours; a mixing and grinding temperature of the ball mill is 15 °C to 30 °C; and a weight percentage of the solid content in the first mixture particles is 25 wt %~40 wt %.

4. The method as claimed in claim 1, wherein the zirconium-contained compound is selected from one of zirconium nitrate (Zr(NO₃)₄), zirconium dioxide (ZrO₂) and zirconium(IV) hydroxide (Zr(OH)₄);
wherein the lanthanum-contained compound is selected from one of lanthanum(III) nitrate (La(NO₃)₃), lanthanum(III) oxide (La₂O₃) and lanthanum hydroxide (La(OH)₃);
wherein the copper-contained compound is selected from one of copper(II) nitrate (Cu(NO₃)₂), copper(II) oxide (CuO) and copper(II) hydroxide (Cu(OH)₂);
wherein the aluminum-contained compound is selected from one of aluminium(III) oxide (Al₂O₃), aluminium hydroxide (Al(OH)₃) and aluminium nitrate (Al(NO₃)₃); and
wherein the lithium-contained compound is selected from one of lithium nitrate (LiNO₃), lithium oxide (Li₂O), lithium carbonate (Li₂CO₃) and lithium hydroxide (LiOH).

5. The method as claimed in claim 1, wherein in the step B, the rotary evaporator is an oil bath assisted rotary evaporator; an oil path temperature of the rotary evaporator is 120 °C; a rotation speed of the rotary evaporator is 25 rpm; and a concentration time of the rotary evaporator is 2.5 to 3 hours.

6. The method as claimed in claim 1, wherein in the step C, the oxygen-free sintering is a vacuum sintering or an atmosphere protected sintering.

7. The method as claimed in claim 1, wherein in the step C, the oxygen-free sintering is an atmosphere protected sintering using an atmosphere formed by nitrogen (N₂) and argon (Ar); a ratio between a volume of the nitrogen and a volume of the argon is 98:2; the oxygen-free sintering is performed by increasing a temperature of the sintering furnace to 750 °C at a rate of 1 °C to 5 °C per minute to heat the first mixture particles for 5 to 6 hours in a stew protection of the atmosphere formed by the nitrogen and argon; and during the oxygen-free sintering, the atmosphere formed by the nitrogen and argon is replaced and replenished at a rate of 0.05 L to 0.15 L per minute.

8. The method as claimed in claim 1, wherein in the step D, each of the second mixture particles has a particle size less than 500 nm.

9. The method as claimed in claim 1, wherein the rotation speed, a filling ratio of a total volume of the zirconium balls and the second mixture particles, the mixing and grinding time, and the mixing and grinding temperature of the ball mill in the step D are identical to the rotation speed, the filling ratio of a total volume of the zirconium balls and first mixture particles, the mixing and grinding time, and the mixing and grinding temperature of the ball mill in the step A, respectively.

10. The method as claimed in claim 1, wherein in the step E, the rotary evaporator is an oil bath assisted rotary evaporator; the oil path temperature of the rotary evaporator is 120 °C; a rotation speed of the rotary evaporator is 25 rpm; and a concentration time of the rotary evaporator is 2.5 to 3 hours.

11. The method as claimed in claim 1, wherein in the step F, the first temperature is 750 °C and the first duration is 2 hours.

12. The method as claimed in claim 11, wherein in the step G, the second temperature is 700 °C; the third temperature is 900 °C~950 °C; the second duration is 6~9 hours; and the second temperature is increased to the third temperature at a rate of 1 °C to 3 °C per minute.

13. The method as claimed in claim 1, wherein the zirconium-contained compound is ZrO₂; the lanthanum-contained compound is La₂O₃; the copper-contained compound is CuO; the aluminum-contained compound is Al₂O₃; and the lithium-contained compound is Li₂CO₃.

14. The method as claimed in claim 13, wherein a chemical equation to produce the modified LLZO through the first stage oxygen-free sintering operation and the second stage sintering operation is:
$$4 {ZrO}_{2} + {3 L {a}_{2} O}_{3} + ( 7 - x - y ) {Li}_{2} {CO}_{3} + x CuO + \frac{y}{3} {Al}_{2} {O}_{3} \to 2 {Li}_{( 7 - x - y )} {Cu}_{\frac{x}{2}} {Al}_{\frac{y}{3}} {La}_{3} Z {r}_{2} {O}_{12} + ( 7 - x - y ) {CO}_{2}$$
and wherein x>0, y>0 and 7−x−y>0.

15. The method as claimed in claim 14, wherein in the chemical equation, 0<x<0.8, 0<y<0.8 and 0.1<x+y<0.8.

16. The method as claimed in claim 14, wherein in the chemical equation, 0<x<0.35, 0<y<0.45 and 0.3<x+y<0.8.

17. The method as claimed in claim 14, wherein when a mole ratio between the ZrO₂, Li₂CO₃, CuO, Al₂O₃, La₂O₃ is 4:(7−x−y):x:y/3:3, the chemical equation achieves a complete reaction; when the mole ratio is not 4:(7−x−y):x:y/3:3, the chemical equation is still performed and some initial compounds which do not react are remained in the final products.
